(19) United States
(12) Patent Application Publication
(10) Pub. No.: US 2015/0298616 A1
(43) Pub. Date: Oct. 22, 2015

(54) VEHICLE DOOR STORAGE COMPARTMENT

(71) Applicant: Johnson Controls Technology Company, Holland, MI (US)

(72) Inventors: Arne Dassen, Holland, MI (US); Jason M. Hipshier, Hudsonville, MI (US); David J. McCarthy, Holland, MI (US); Kyle B. Beeck, Grand Haven, MI (US); Randy VanHoof, Zeeland, MI (US); Andrew Robert Butz, Holland, MI (US)

(73) Assignee: Johnson Controls Technology Company, Holland, MI (US)

(21) Appl. No.: 14/418,062

(22) PCT Filed: Jul. 31, 2013
(86) PCT No.: PCT/US2013/053018

§ 371 Date: Jan. 28, 2015

Related U.S. Application Data
(60) Provisional application No. 61/678,929, filed on Aug. 2, 2012.

(51) Int. Cl. B60R 7/04; B60N 2/46; B60J 5/04

(52) U.S. Cl. CPC B60R 7/046; B60J 5/0411; B60N 2/46

(57) ABSTRACT

A vehicle door assembly having a storage compartment. One vehicle door assembly includes a support structure. The vehicle door assembly also includes an open storage compartment coupled to the support structure. The open storage compartment is positioned in a middle portion of the vehicle door assembly along a vertical axis of the vehicle door assembly. Further, the open storage compartment includes a cavity that is not within an armrest.

### CROSS REFERENCE TO RELATED APPLICATION

This application claims priority from and the benefit of U.S. Provisional Application Ser. No. 61/678,929, entitled “VEHICLE DOOR STORAGE COMPARTMENT”, filed Aug. 2, 2012, which is hereby incorporated by reference in its entirety.

### BACKGROUND

The invention relates generally to motor vehicles, and more particularly, to a storage compartment for a door of a motor vehicle.

Motor vehicles may provide various storage compartments for storing items within the vehicle interior. For example, items may be stored in a glove box, under a seat, in a trunk of the vehicle, and so forth. Further, vehicle doors may provide various options for storing small items. For example, some motor vehicles include a storage compartment at the bottom of a vehicle door. Moreover, certain motor vehicles may provide an enclosure in the door for storing items.

While vehicle doors may include various storage compartments, certain cavities of the motor vehicle door may also be used to hold small items, even if the cavities were not intended for such a purpose. For example, hand grips within an armrest may be used to hold small items. However, the hand grip openings are small and not suitable for storing larger items. In addition, the hand grip openings may be difficult for a driver of the vehicle to access.

### BRIEF DESCRIPTION OF THE INVENTION

The present invention relates to a vehicle door assembly having a support structure. The vehicle door assembly also includes an open storage compartment coupled to the support structure. The open storage compartment is positioned in a middle portion of the vehicle door assembly along a vertical axis of the vehicle door assembly. Further, the open storage compartment includes a cavity that is not within an armrest.

The present invention also relates to a vehicle door assembly having an open storage compartment coupled to the vehicle door assembly. The open storage compartment includes a cavity that is not within an armrest. Further, a top portion of the open storage compartment is at least partially uncovered. In addition, the open storage compartment is positioned in a central portion of the vehicle door assembly along a vertical axis of the vehicle door assembly.

The present invention further relates to a vehicle door assembly including an open storage compartment coupled to the vehicle door assembly. The open storage compartment includes a cavity that is not within an armrest. Further, the open storage compartment is positioned in a middle portion of the vehicle door assembly along a vertical axis of the vehicle door assembly.

### DRAWINGS

FIG. 1 is a perspective view of an exemplary vehicle that may include an open storage compartment in a door of the vehicle.

FIG. 2 is a perspective view of an embodiment of a vehicle door assembly which includes an open storage compartment.

FIG. 3 is a perspective view of an embodiment of a vehicle door assembly which includes an armrest positioned over a portion of an open storage compartment.

FIG. 4 is a cross-sectional view of an embodiment of a vehicle door assembly which includes an open storage compartment.

### DETAILED DESCRIPTION

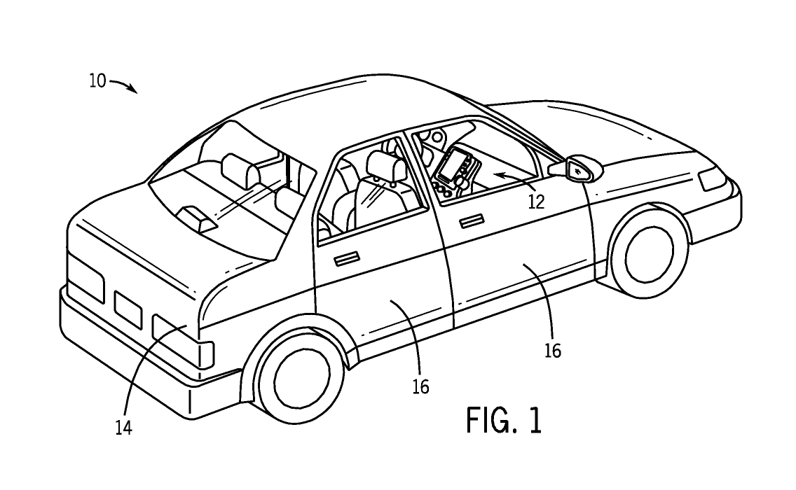

FIG. 1 is a perspective view of an exemplary vehicle 10 that may include an open storage compartment in a door of the vehicle. The vehicle 10, in this case a car, includes an interior 12 and an exterior 14. Furthermore, the vehicle 10 includes one or more door assemblies 16. As may be appreciated, a portion of each door assembly 16 is exposed to the interior 12 of the vehicle 10, and a portion of each door assembly 16 is exposed to the exterior 14 of the vehicle 10. Certain door assemblies 16 may include an open storage compartment for storing items. It should be noted that the term “open” as it relates to an “open storage compartment” indicates that the storage compartment is not completely enclosed. For example, an open storage compartment does not have a hinged lid that completely encloses a storage space within the compartment when the lid is closed. As another example, an open storage compartment may include side walls and a bottom portion; however, in such a configuration, the open storage compartment may not include a top portion that completely encloses the storage space. It should be noted that if the top portion partially covers the storage space, then the storage compartment is considered an “open” storage compartment because it is not completely enclosed.

As may be appreciated, an open storage compartment provides a vehicle occupant convenient access to the contents of the storage compartment. The open storage compartment may be located in a middle portion of a door assembly 16 (e.g., at a position near where an armrest would otherwise be located). Such a position enables an occupant to access the contents of the storage compartment without reaching and/or bending down (e.g., unlike storage compartments positioned at the bottom of a door assembly 16). Thus, an occupant of the vehicle 10 may access the open storage compartment in the door assembly 16 with minimal inconvenience.

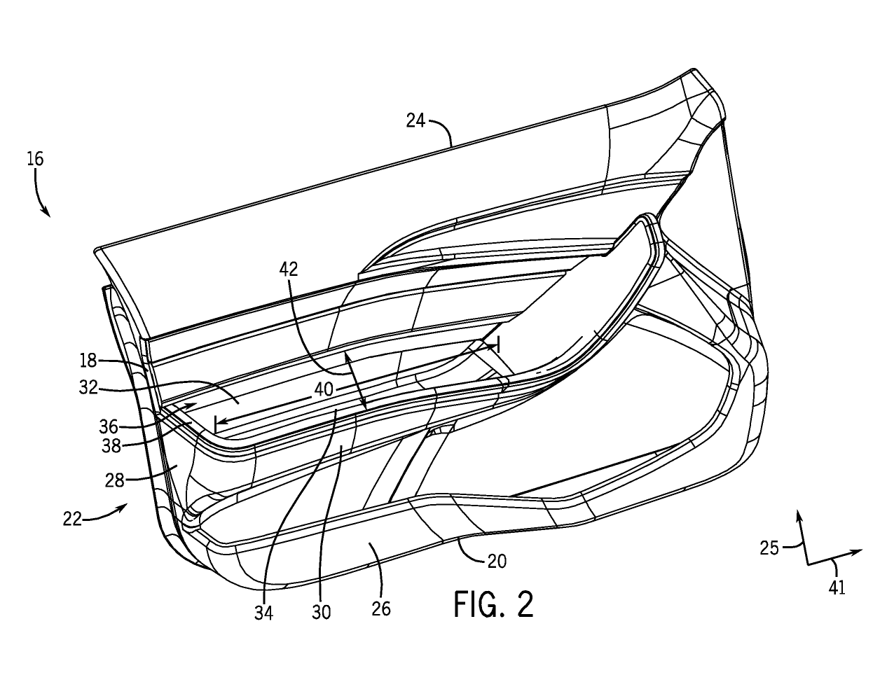

FIG. 2 is a perspective view of an embodiment of the vehicle door assembly 16 which includes an open storage compartment. Specifically, the vehicle door assembly 16 includes a support structure 18 to provide support to various components of the vehicle door assembly 16. Further, the vehicle door assembly 16 includes a bottom portion 20 (e.g., positioned toward the bottom of the vehicle 10), a middle portion 22 (e.g., positioned toward a center portion of the vehicle door assembly 16, such as where an armrest may otherwise be positioned), and a top portion 24 (e.g., positioned toward a portion of the vehicle door assembly 16 adjacent to a window). A vertical axis 25 of the vehicle door assembly 16 extends from the bottom portion 20 to the top portion 24.

As illustrated, the vehicle door assembly 16 includes a floor storage compartment 26 for storing items near the bottom portion 20 of the vehicle door assembly 16. The vehicle door assembly 16 also includes an open storage compartment 28 positioned in the middle portion 22 of the vehicle door assembly 16. In some embodiments, the open storage compartment 28 may be positioned adjacent to an armrest. In other embodiments, the open storage compartment 28 may be positioned above or below an armrest coupled to the door assembly 16.

The open storage compartment 28 includes a first side wall 30, a second side wall 32, and a bottom portion 34 that collectively form a cavity for storing items. It should be noted that the cavity formed by the open storage compartment 28 is not a cavity within an armrest, but a separate element of the door assembly 16. As illustrated, a top portion 36 of the open storage compartment 28 is completely open so that the storage compartment 28 may be accessed by a vehicle occupant. There is no lid, or other covering configured to cover the top portion 36, as such the open storage compartment 28 remains open. Trim 38 may be formed along a top end of the open storage compartment 28 (e.g., to cover the top edge and/or for aesthetic reasons).

As illustrated, the open storage compartment 28 provides a large cavity for storing items. As such, a length 40 of the storage compartment 28 may extend along a majority of the longitudinal extent of a longitudinal axis 41 of the vehicle door assembly 16. For example, the length 40 may be any suitable length, such as a length greater than approximately fifteen centimeters. Further, a width 42 of the storage compartment 28 may be any suitable width, such as a width greater than approximately five centimeters. With the open storage compartment 28, items may be stored conveniently, and may be easily accessible.

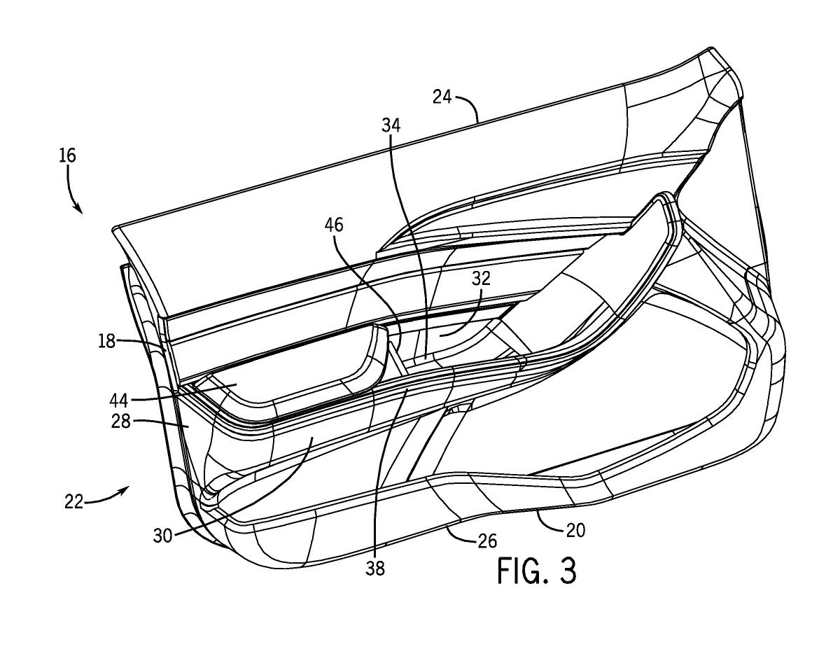

FIG. 3 is a perspective view of an embodiment of the vehicle door assembly 16 which includes an armrest 44 positioned over a portion of the open storage compartment 28. The armrest 44 is configured to provide support to an occupant of the vehicle. While the armrest 44 may block access to a portion of the open storage compartment 28, part of the top portion 36 is accessible because the open storage compartment 28 is not fully enclosed by the armrest 44. As may be appreciated, the open storage compartment 28 may be configured to enable the armrest 44 to be coupled to the open storage compartment 28 (e.g., via tracks in the open storage compartment 28 and protrusions from the armrest 44).

As illustrated, the open storage compartment 28 may include a support device 46 extending between the first side wall 30 and the second side wall 32, and configured to provide structural support to the first side wall 30 and to the second side wall 32. The support device 46 may be configured to block movement of the first side wall 30 away from the second side wall 32. As may be appreciated, the support device 46 may be coupled inside the open storage compartment 28 as illustrated, or the support device 46 may be coupled to the vehicle door assembly 16 outside of the open storage compartment 28. Furthermore, the support device 46 may function as a divider within the open storage compartment 28.

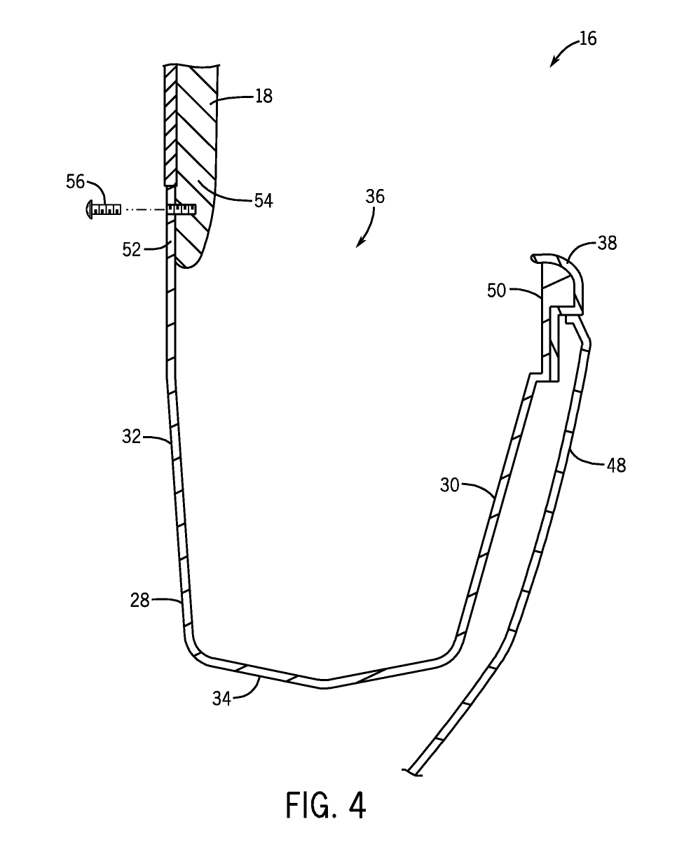

FIG. 4 is a cross-sectional view of an embodiment of the vehicle door assembly 16 which includes the open storage compartment 28. The support structure 18 of the vehicle door assembly 16 may include a first interior surface 48 positioned adjacent to the first side wall 30. During assembly, the trim 38 may be positioned around an end 50 of the first side wall 30 of the open storage compartment 28 to form a trimmed upper end. Further, an end 52 of the second side wall 32 may be positioned behind a portion of a second interior surface 54. The end 52 of the second side wall 32 may be attached to the second interior surface 54 in any suitable manner. For example, a fastener 56 (e.g., one or more fasteners) may be used to attach the end 52 of the second side wall 32 to the second interior surface 54. In other embodiments, the end 52 of the second side wall 32 may be attached to the second interior surface 54 using heat staking.

To manufacture the vehicle door assembly 16, trim 38 may be installed around the end 50 of the open storage compartment 28. Thereafter, the open storage compartment may be inserted between the first interior surface 48 and the second interior surface 54. The end 52 may be inserted behind the second interior surface 54 and attached to the second interior surface 54, as described above. The trim 38 may rest on the first interior surface 48.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A vehicle door assembly comprising:
a support structure; and
an open storage compartment coupled to the support structure, wherein the open storage compartment is positioned in a middle portion of the vehicle door assembly along a vertical axis of the vehicle door assembly, and the open storage compartment comprises a cavity that is not within an armrest.

2. The vehicle door assembly of claim 1, wherein the open storage compartment is coupled to the support structure via fasteners.

3. The vehicle door assembly of claim 1, wherein the open storage compartment is coupled to the support structure via heat staking.

4. The vehicle door assembly of claim 1, wherein the open storage compartment comprises a first side wall, a second side wall, and a bottom portion.

5. The vehicle door assembly of claim 4, comprising a support device extending between the first side wall and the second side wall of the open storage compartment, and configured to block movement of the first side wall away from the second side wall.

6. The vehicle door assembly of claim 1, comprising an armrest coupled to the open storage compartment.

7. The vehicle door assembly of claim 6, wherein the armrest is configured to cover a portion of the open storage compartment.

8. The vehicle door assembly of claim 1, wherein the open storage compartment comprises a divider disposed within the opening.

9. The vehicle door assembly of claim 1, wherein the open storage compartment comprises a trimmed upper end.

10. The vehicle door assembly of claim 1, wherein a length of the open storage compartment is greater than approximately fifteen centimeters.

11. The vehicle door assembly of claim 10, wherein a width of the open storage compartment is greater than approximately five centimeters.

12. The vehicle door assembly of claim 1, wherein a top portion of the open storage compartment is at least partially uncovered.

13. A vehicle door assembly comprising:
an open storage compartment coupled to the vehicle door assembly, wherein the open storage compartment comprises a cavity that is not within an armrest, a top portion of the open storage compartment is at least partially uncovered, and the open storage compartment is positioned in a central portion of the vehicle door assembly along a vertical axis of the vehicle door assembly.

14. The vehicle door assembly of claim 13, wherein the open storage compartment is configured to enable an armrest to be coupled to the open storage compartment.

15. The vehicle door assembly of claim 14, comprising an armrest coupled to the open storage compartment, wherein the armrest is configured to cover a portion of the open storage compartment.

16. The vehicle door assembly of claim 13, comprising a support device configured to provide structural support to side walls of the open storage compartment.

17. A vehicle door assembly comprising:
an open storage compartment coupled to the vehicle door assembly, wherein the open storage compartment comprises a cavity that is not within an armrest, and the open storage compartment is positioned in a middle portion of the vehicle door assembly along a vertical axis of the vehicle door assembly.

18. The vehicle door assembly of claim 17, wherein the open storage compartment is coupled to a support structure of the vehicle door assembly via fasteners.

19. The vehicle door assembly of claim 17, wherein the open storage compartment is coupled to a support structure of the vehicle door assembly via heat staking.

20. The vehicle door assembly of claim 17, wherein the open storage compartment comprises a divider disposed within the opening.
